(19) United States
(12) Patent Application Publication
(10) Pub. No.: US 2025/0089810 A1
(43) Pub. Date: Mar. 20, 2025

(54) AEROSOL GENERATING DEVICE AND OPERATING METHOD THEREOF

(71) Applicant: KT&G CORPORATION, Daejeon (KR)

(72) Inventors: Yong Hwan KIM, Gyeonggi-do (KR); Young Bum KWON, Gyeonggi-do (KR); Dong Sung KIM, Seoul (KR); Hun Il LIM, Seoul (KR)

(73) Assignee: KT&G CORPORATION, Daejeon (KR)

(21) Appl. No.: 18/565,357

(22) PCT Filed: Sep. 5, 2023
(86) PCT No.: PCT/KR2023/013265

§ 371 Date: Nov. 29, 2023

(30) Foreign Application Priority Data
Sep. 5, 2022 (KR) 10-2022-0112372
Jan. 16, 2023 (KR) 10-2023-0006313

(51) Int. Cl. A24F 40/65; A24F 40/10; A24F 40/20; A24F 40/30; A24F 40/49; A24F 40/51; A24F 40/57; A24F 40/60

(52) U.S. Cl. CPC A24F 40/65; A24F 40/49; A24F 40/57; A24F 40/60; A24F 40/10; A24F 40/20; A24F 40/30; A24F 40/51

(57) ABSTRACT

An aerosol generating device according to an embodiment includes a heater, a battery configured to supply power to the heater, a communication interface connected to an external device, and a controller configured to communicate with the external device only when an external input is received in a state in which a connection between the communication interface and the external device is detected.

### TECHNICAL FIELD

The present disclosure relates to an aerosol generating device and an operating method thereof. Specifically, the present disclosure relates to an aerosol generating device that may protect information of the aerosol generating device and an operating method thereof.

### BACKGROUND ART

Recently, the demand for a smoking method that replaces a general cigarette has been increased. For example, there is an increasing demand for a method of generating an aerosol by heating an aerosol generating material in a cigarette without combustion. Accordingly, research on heating type cigarettes and heating type aerosol generating devices is actively conducted.

In general, an aerosol generating device may be connected to an external device, such as a personal computer (PC) via a communication interface. Even when communication is performed through encryption and decryption, a protocol can be exposed through a syntax analysis program, such as a terminal or a parser.

### DISCLOSURE OF INVENTION

### Technical Problem

The present disclosure provides an aerosol generating device that may prevent hooking of important information of the aerosol generating device, and an operating method of the aerosol generating device.

Objects to be achieved by embodiments are not limited to the objects described above, and objects not described will be clearly understood by those skilled in the art to which the embodiments belong from the present specification and accompanying drawings.

### Solution to Problem

An aerosol generating device according to an embodiment includes a heater, a battery configured to supply power to the heater, a communication interface connectable to an external device, and a controller configured to communicate with the external device only when an external input is received while the communication interface is connected to the external device.

An operating method of an aerosol generating device, according to an embodiment, includes detecting a connection with an external device through a communication interface, determining whether a preset external input is received through a user input unit while the detected connection is maintained, and communicating with the external device when the external input is received through the user input unit.

### Advantageous Effects of Invention

An aerosol generating device and an operating method thereof, according to various embodiments of the present disclosure, may prevent important information of the aerosol generating device from being hooked, by requiring a separate external input when connected to an external device through a communication interface.

Effects of the embodiments are not limited to the effects described above, and effects not described will be clearly understood by those skilled in the art to which the embodiments belong from the present specification and the accompanying drawings.

### BRIEF DESCRIPTION OF DRAWINGS

FIGS. 1 to 3 are views illustrating examples in which a cigarette is inserted into an aerosol generating device.

FIGS. 4 and 5 are views illustrating examples of cigarettes.

FIG. 6 is a block diagram illustrating an example in which an aerosol generating device is communicatively connected to an external device, according to an embodiment.

FIG. 7 is a block diagram illustrating a hardware configuration of an aerosol generating device according to an embodiment.

FIG. 8 is a flowchart illustrating an operation of an aerosol generating device when an external input is received, according to an embodiment.

FIG. 9 is a flowchart illustrating an operation of an aerosol generating device when an external input is not received, according to an embodiment.

FIG. 10 is a flowchart illustrating an operation of an aerosol generating device when an external input is received, according to another embodiment.

FIG. 11 is a flowchart illustrating an operation of an aerosol generating device when an external input is not received, according to another embodiment.

FIG. 12 is a block diagram of an aerosol generating device according to another embodiment.

FIG. 13 is a flowchart illustrating an operating method of an aerosol generating device, according to an embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, embodiments of the present disclosure will be described in detail with reference to the accompanying drawings such that those skilled in the art to which the present disclosure belongs can easily implement the embodiments. However, the present disclosure may be implemented in many different forms and is not limited to the embodiments described herein.

Hereinafter, embodiments of the present disclosure are described in detail with reference to the drawings.

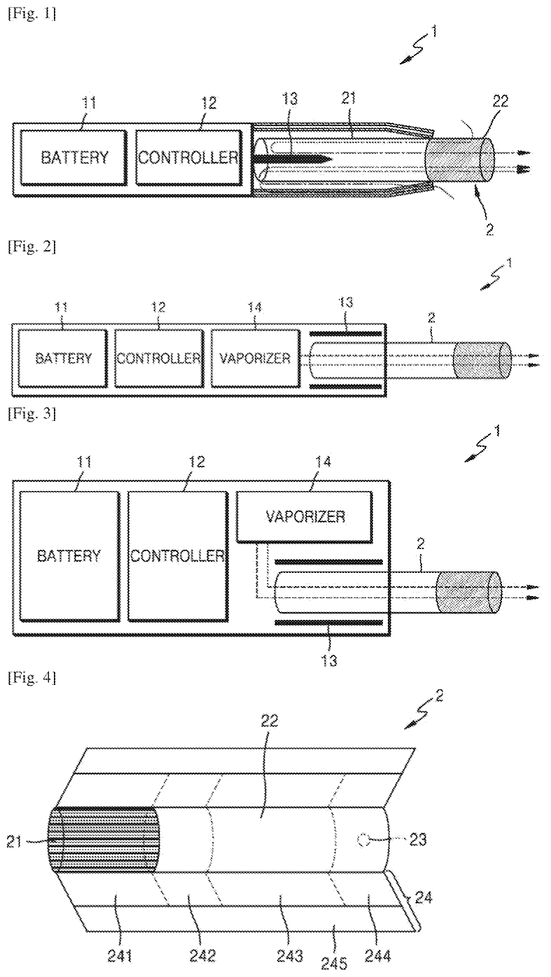

FIGS. 1 through 3 are diagrams showing examples in which an aerosol generating article is inserted into an aerosol generating device.

Referring to FIG. 1, the aerosol generating device 1 may include a battery 11, a controller 12, and a heater 13. Referring to FIGS. 2 and 3, the aerosol generating device 1 may further include a vaporizer 14. Also, the aerosol generating article 2 may be inserted into an inner space of the aerosol generating device 1.

FIGS. 1 through 3 illustrate components of the aerosol generating device 1, which are related to the present embodiment. Therefore, it will be understood by one of ordinary skill in the art related to the present embodiment that other general-purpose components may be further included in the aerosol generating device 1, in addition to the components illustrated in FIGS. 1 through 3.

Also, FIGS. 2 and 3 illustrate that the aerosol generating device 1 includes the heater 13. However, as necessary, the heater 13 may be omitted.

FIG. 1 illustrates that the battery 11, the controller 12, and the heater 13 are arranged in series. Also, FIG. 2 illustrates that the battery 11, the controller 12, the vaporizer 14, and the heater 13 are arranged in series. Also, FIG. 3 illustrates that the vaporizer 14 and the heater 13 are arranged in parallel. However, the internal structure of the aerosol generating device 1 is not limited to the structures illustrated in FIGS. 1 through 3. In other words, according to the design of the aerosol generating device 1, the battery 11, the controller 12, the heater 13, and the vaporizer 14 may be differently arranged.

When the aerosol generating article 2 is inserted into the aerosol generating device 1. the aerosol generating device 1 may operate the heater 13 and/or the vaporizer 14 to generate aerosol from the aerosol generating article 2 and/or the vaporizer 14. The aerosol generated by the heater 13 and/or the vaporizer 14 is delivered to a user by passing through the aerosol generating article 2.

As necessary, even when the aerosol generating article 2 is not inserted into the aerosol generating device 1, the aerosol generating device 1 may heat the heater 13.

The battery 11 may supply power to be used for the aerosol generating device 1 to operate. For example, the battery 11 may supply power to heat the heater 13 or the vaporizer 14, and may supply power for operating the controller 12. Also, the battery 11 may supply power for operations of a display, a sensor, a motor, etc. mounted in the aerosol generating device 1.

The controller 12 may generally control operations of the aerosol generating device 1. In detail, the controller 12 may control not only operations of the battery 11, the heater 13, and the vaporizer 14, but also operations of other components included in the aerosol generating device 1. Also, the controller 12 may check a state of each of the components of the aerosol generating device 1 to determine whether or not the aerosol generating device 1 is able to operate.

The controller 12 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 13 may be heated by the power supplied from the battery 11. For example, when the aerosol generating article 2 is inserted into the aerosol generating device 1, the heater 13 may be located outside the aerosol generating article 2. Thus, the heated heater 13 may increase a temperature of an aerosol generating material in the aerosol generating article 2.

The heater 13 may include an electro-resistive heater. For example, the heater 13 may include an electrically conductive track, and the heater 13 may be heated when currents flow through the electrically conductive track. However, the heater 13 is not limited to the example described above and may include all heaters which may be heated to a desired temperature. Here, the desired temperature may be pre-set in the aerosol generating device 1 or may be set by a user.

As another example, the heater 13 may include an induction heater. In detail, the heater 13 may include an electrically conductive coil for heating an aerosol generating article in an induction heating method, and the aerosol generating article may include a susceptor which may be heated by the induction heater.

For example, the heater 13 may include a tube-type heating element, a plate-type heating element, a needle-type heating element, or a rod-type heating element, and may heat the inside or the outside of the aerosol generating article 2, according to the shape of the heating element.

Also, the aerosol generating device 1 may include a plurality of heaters 13. Here, the plurality of heaters 13 may be inserted into the aerosol generating article 2 or may be arranged outside the aerosol generating article 2. Also, some of the plurality of heaters 13 may be inserted into the aerosol generating article 2 and the others may be arranged outside the aerosol generating article 2. In addition, the shape of the heater 13 is not limited to the shapes illustrated in FIGS. 1 through 3 and may include various shapes.

The vaporizer 14 may generate aerosol by heating a liquid composition and the generated aerosol may pass through the aerosol generating article 2 to be delivered to a user. In other words, the aerosol generated via the vaporizer 14 may move along an air flow passage of the aerosol generating device 1 and the air flow passage may be configured such that the aerosol generated via the vaporizer 14 passes through the aerosol generating article 2 to be delivered to the user.

For example, the vaporizer 14 may include a liquid storage, a liquid delivery element, and a heating element, but it is not limited thereto. For example, the liquid storage, the liquid delivery element, and the heating element may be included in the aerosol generating device 1 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 14 or may be formed integrally with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but it is not limited thereto.

The aerosol generating device 1 may further include general-purpose components in addition to the battery 11, the controller 12, the heater 13, and the vaporizer 14. For example, the aerosol generating device I may include a display capable of outputting visual information and/or a motor for outputting haptic information. Also, the aerosol generating device 1 may include at least one sensor (a puff sensor, a temperature sensor, an aerosol generating article insertion detecting sensor, etc.). Also, the aerosol generating device 1 may be formed as a structure that, even when the aerosol generating article 2 is inserted into the aerosol generating device 1, may introduce external air or discharge internal air.

Although not illustrated in FIGS. 1 through 3, the aerosol generating device 1 and an additional cradle may form together a system. For example, the cradle may be used to charge the battery 11 of the aerosol generating device 1. Alternatively, the heater 13 may be heated when the cradle and the aerosol generating device 1 are coupled to each other.

The aerosol generating article 2 may be similar to a general combustive cigarette. For example, the aerosol generating article 2 may be divided into a first portion including an aerosol generating material and a second portion including a filter, etc. Alternatively, the second portion of the aerosol generating article 2 may also include an aerosol generating material. For example, an aerosol generating material made in the form of granules or capsules may be inserted into the second portion.

The entire first portion may be inserted into the aerosol generating device 1, and the second portion may be exposed to the outside. Alternatively, only a portion of the first portion may be inserted into the aerosol generating device 1, or the entire first portion and a portion of the second portion may be inserted into the aerosol generating device 1. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol generating device 1. For example, opening and closing of the air passage and/or a size of the air passage formed in the aerosol generating device 1 may be adjusted by the user. Accordingly, the amount and the quality of smoking may be adjusted by the user. As another example, the external air may flow into the aerosol generating article 2 through at least one hole formed in a surface of the aerosol generating article 2.

Hereinafter, the examples of the aerosol generating article 2 will be described with reference to FIGS. 4 and 5.

FIGS. 4 and 5 illustrate examples of the aerosol generating article.

Referring to FIG. 4, the aerosol generating article 2 may include a tobacco rod 21 and a filter rod 22. FIG. 4 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

The diameter of the cigarette 2 is within the range of 5 mm to 9 mm, and the length may be about 48 mm, but is not limited thereto. For example, the length of the tobacco rod 21 is about 12 mm, the length of the first segment of the filter rod 22 is about 10 mm, the length of the second segment of the filter rod 22 is about 14 mm, the length of the filter rod 22 The length of the third segment of may be about 12 mm, but is not limited thereto.

The aerosol generating article 2 may be packaged using at least one wrapper 24. The wrapper 24 may have at least one hole through which external air may be introduced or internal air may be discharged. For example, the aerosol generating article 2 may be packaged by one wrapper 24. As another example, the aerosol generating article 2 may be doubly packaged by two or more wrappers 24. For example, the tobacco rod 210 may be packaged by a first wrapper 241, and the filter rod 220 may be packaged by wrappers 242, 243, 244. Also, the entire aerosol generating article 2 may be repackaged by another single wrapper 245. When the filter rod 220 includes a plurality of segments, each segment may be packaged by wrappers 242, 243, 244.

The first wrapper 241 and the second wrapper 242 may be formed of general filter wrapping paper. For example, the first wrapper 241 and the second wrapper 242 may be porous wrapping paper or non-porous wrapping paper. Also, the first wrapper 241 and the second wrapper 242 may be made of an oil-resistant paper sheet and an aluminum laminate packaging material.

The third wrapper 243 may be made of a hard wrapping paper. For example, a basis weight of the third wrapper 243 may be within a range of 88 g/m2 to 96 g/m2. For example, the basis weight of the third wrapper 243 may be within a range of 90 g/m2 to 94 g/m2. Also, a total thickness of the third wrapper 243 may be within a range of 120 μm to 130 μm. For example, the total thickness of the third wrapper 243 may be 125 μm.

The fourth wrapper 244 may be made of an oil-resistant hard wrapping paper. For example, a basis weight of the fourth wrapper 244 may be within a range of about 88 g/m2 to about 96 g/m2. For example, the basis weight of the fourth wrapper 244 may be within a range of 90 g/m2 to 94 g/m2. Also, a total thickness of the fourth wrapper 244 may be within a range of 120 μm to 130 μm. For example, the total thickness of the fourth wrapper 244 may be 125 μm.

The fifth wrapper 245 may be made of a sterilized paper (MFW). Here, the MFW refers to a paper specially manufactured to have enhanced tensile strength, water resistance, smoothness, and the like, compared to ordinary paper. For example, a basis weight of the fifth wrapper 245 may be within a range of 57 g/m2 to 63 g/m2. For example, a basis weight of the fifth wrapper 245 may be about 60 g/m2. Also, the total thickness of the fifth wrapper 245 may be within a range of 64 μm to 70 μm. For example, the total thickness of the fifth wrapper 245 may be 67 μm.

A predetermined material may be included in the fifth wrapper 245. Here, an example of the predetermined material may be, but is not limited to, silicon. For example, silicon exhibits characteristics like heat resistance with little change due to the temperature, oxidation resistance, resistances to various chemicals, water repellency, electrical insulation, etc. However, any material other than silicon may be applied to (or coated on) the fifth wrapper 245 without limitation as long as the material has the above-mentioned characteristics.

The fifth wrapper 245 may prevent the stick 20 from being burned. For example, when the tobacco rod 210 is heated by the heater 13, there is a possibility that the stick 2 is burned. In detail, when the temperature is raised to a temperature above the ignition point of any one of materials included in the tobacco rod 310, the stick 2 may be burned. Even in this case, since the fifth wrapper 245 include a non-combustible material, the burning of the stick 2 may be prevented.

Furthermore, the fifth wrapper 245 may prevent the aerosol generating device 1 from being contaminated by substances formed by the stick 2. Through puffs of a user, liquid substances may be formed in the stick 2. For example, as the aerosol formed by the stick 2 is cooled by the outside air, liquid materials (e.g., moisture, etc.) may be formed. As the fifth wrapper 245 wraps the stick 2, the liquid materials formed in the stick 2 may be prevented from being leaked out of the stick 2.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulous acetate filter. For example, the first segment may be a tube-type structure having a hollow inside. The first segment may prevent an internal material of the tobacco rod 21 from being pushed back when the heater 110 is inserted into the tobacco rod 21 and may also provide a cooling effect to aerosol. A diameter of the hollow included in the first segment may be an appropriate diameter within a range of 2 mm to 4.5 mm but is not limited thereto.

The length of the first segment may be an appropriate length within a range of 4 mm to 30 mm but is not limited thereto. For example, the length of the first segment may be 10 mm but is not limited thereto.

The hardness of the first segment may be adjusted by adjusting the content of the plasticizer during manufacture of the first segment. In addition, the first segment may be manufactured by inserting a structure such as a film or a tube made of the same or different material into the inside (e.g., hollow).

The second segment of the filter rod 22 cools the aerosol which is generated when the heater 13 heats the tobacco rod 21. Therefore, the user may puff the aerosol which is cooled at an appropriate temperature.

The length or diameter of the second segment may be variously determined according to the shape of the stick 2. For example, the length of the second segment may be an appropriate length within a range of 7 mm to 20 mm. Preferably, the length of the second segment may be about 14 mm but is not limited thereto.

The second segment may be manufactured by weaving a polymer fiber. In this case, a flavoring liquid may also be applied to the fiber formed of the polymer. Alternatively, the second segment may be manufactured by weaving together an additional fiber coated with a flavoring liquid and a fiber formed of a polymer. Alternatively, the second segment may be formed by a crimped polymer sheet.

For example, a polymer may be formed of a material selected from the group consisting of polyethylene (PE), polypropylene (PP), polyvinyl chloride (PVC), polyethylene terephthalate (PET), polylactic acid (PLA), cellulous acetate (CA), and aluminum coil.

As the second segment is formed by the woven polymer fiber or the crimped polymer sheet, the second segment may include a single channel or a plurality of channels extending in a longitudinal direction. Here, a channel refers to a passage through which a gas (e.g., air or aerosol) passes.

For example, the second segment formed of the crimped polymer sheet may be formed from a material having a thickness between about 5 μm and about 300 μm, for example, between about 10 μm and about 250 μm. Also, a total surface area of the second segment may be between about 300 mm2/mm and about 1000 mm2/mm. In addition, an aerosol cooling element may be formed from a material having a specific surface area between about 10 mm2/mg and about 100 mm2/mg.

The second segment may include a thread including a volatile flavor component. Here, the volatile flavor component may be menthol but is not limited thereto. For example, the thread may be filled with a sufficient amount of menthol to provide the second segment with menthol of 1.5 mg or more.

The third segment of the filter rod 22 may be a cellulous acetate filter. The length of the third segment may be an appropriate length within a range of 4 mm to 20 mm. For example, the length of the third segment may be about 12 mm but is not limited thereto.

The filter rod 22 may be manufactured to generate flavors. Alternatively, a separate fiber coated with flavoring liquid may be inserted into the third segment. The aerosol generated in the tobacco rod 21 is cooled as it passes through the second segment of the filter rod 22, and the cooled aerosol is delivered to the user through the third segment. Therefore, when the flavoring element is added to the third segment, the effect of enhancing the persistence of the flavor delivered to the user may occur.

Also, the filter rod 22 may include at least one capsule 23. Here, the capsule 23 may generate a flavor. The capsule 23 may generate an aerosol. For example, the capsule 23 may have a configuration in which a liquid including a flavoring material is wrapped with a film. The capsule 23 may have a spherical or cylindrical shape but is not limited thereto.

Referring to FIG. 5, a stick 3 may further include a front-end plug 33. The front-end plug 33 may be located on a side of a tobacco rod 31, the side not facing a filter rod 32. The front-end plug 33 may prevent the tobacco rod 31 from being detached and prevent liquefied aerosol from flowing into the aerosol generating device 1 from the tobacco rod 31, during smoking.

The filter rod 32 may include a first segment 321 and a second segment 322. The first segment 321 may correspond to the first segment of the filter rod 22 of FIG. 4, and the segment 322 may correspond to the third segment of the filter rod 22 of FIG. 4.

A diameter and a total length of the stick 3 may correspond to the diameter and a total length of the stick 2 of FIG. 4. For example, a length of the front-end plug 33 may be about 7 mm, a length of the tobacco rod 31 may be about 15 mm, a length of the first segment 321 may be about 12 mm, and a length of the second segment 322 may be about 14 mm, but embodiments are not limited thereto.

The stick 3 may be wrapped using at least one wrapper 35. The wrapper 35 may have at least one hole through which external air may be introduced or internal air may be discharged. For example, the front-end plug 33 may be wrapped using a first wrapper 351, the tobacco rod 31 may be wrapped using a second wrapper 352, the first segment 321 may be wrapped using a third wrapper 353, and the second segment 322 may be wrapped using a fourth wrapper 354. Also, the entire stick 3 may be re-wrapped using a fifth wrapper 355.

In addition, the fifth wrapper 355 may have at least one perforation 36 formed therein. For example, the perforation 36 may be formed in an area of the fifth wrapper 355 surrounding the tobacco rod 31 but is not limited thereto. For example, the perforation 36 may transfer heat formed by the heater 13 illustrated in FIG. 3 into the tobacco rod 31.

Also, the second segment 322 may include at least one capsule 34. Here, the capsule 34 may generate a flavor. The capsule 34 may generate an aerosol. For example, the capsule 34 may have a configuration in which a liquid including a flavoring material is wrapped with a film. The capsule 34 may have a spherical or cylindrical shape but is not limited thereto.

The first wrapper 351 may be formed by combining general filter wrapping paper with a metal foil such as an aluminum coil. For example, a total thickness of the first wrapper 351 may be within a range of 45 μm to 55 μm. For example, the total thickness of the first wrapper 351 may be 50.3 μm. Also, a thickness of the metal coil of the first wrapper 351 may be within a range 6 μm to 7 μm. For example, the thickness of the metal coil of the first wrapper 351 may be 6.3 μm. In addition, a basis weight of the first wrapper 351 may be within a range of 50 g/m2 to 55 g/m2. For example, the basis weight of the first wrapper 351 may be 53 g/m2.

The second wrapper 352 and the third wrapper 353 may be formed of general filter wrapping paper. For example, the second wrapper 352 and the third wrapper 353 may be porous wrapping paper or non-porous wrapping paper.

For example, porosity of the second wrapper 352 may be 35000 CU but is not limited thereto. Also, a thickness of the second wrapper 352 may be within a range of 70 μm to 80 μm. For example, the thickness of the second wrapper 352 may be 78 μm. A basis weight of the second wrapper 352 may be within a range of 20 g/m2 to 25 g/m2. For example, the basis weight of the second wrapper 352 may be 23.5 g/m2.

For example, porosity of the third wrapper 353 may be 24000 CU but is not limited thereto. Also, a thickness of the third wrapper 353 may be in a range of about 60 μm to about 70 μm. For example, the thickness of the third wrapper 353 may be 68 μm. A basis weight of the third wrapper 353 may be in a range of about 20 g/m2 to about 25 g/m2. For example, the basis weight of the third wrapper 353 may be 21 g/m2.

The fourth wrapper 354 may be formed of PLA laminated paper. Here, the PLA laminated paper refers to three-layer paper including a paper layer, a PLA layer, and a paper layer. For example, a thickness of the fourth wrapper 353 may be in a range of 100 μm to 1200 μm. For example, the thickness of the fourth wrapper 353 may be 110 μm. Also, a basis weight of the fourth wrapper 354 may be in a range of 80 g/m2 to 100 g/m2. For example, the basis weight of the fourth wrapper 354 may be 88 g/m2.

The fifth wrapper 355 may be formed of sterilized paper (MFW). Here, the sterilized paper (MFW) refers to paper which is particularly manufactured to improve tensile strength, water resistance, smoothness, and the like more than ordinary paper. For example, a basis weight of the fifth wrapper 355 may be in a range of 57 g/m2 to 63 g/m2. For example, the basis weight of the fifth wrapper 355 may be 60 g/m2. Also, a thickness of the fifth wrapper 355 may be in a range of 64 μm to 70 μm. For example, the thickness of the fifth wrapper 355 may be 67 μm.

The fifth wrapper 355 may include a preset material added thereto. An example of the material may include silicon, but it is not limited thereto. Silicon has characteristics such as heat resistance robust to temperature conditions, oxidation resistance, resistance to various chemicals, water repellency to water, and electrical insulation, etc. Besides silicon, any other materials having characteristics as described above may be applied to (or coated on) the fifth wrapper 355 without limitation.

The front-end plug 33 may be formed of cellulous acetate. For example, the front-end plug 33 may be formed by adding a plasticizer (e.g., triacetin) to cellulous acetate tow. Mono-denier of filaments constituting the cellulous acetate tow may be in a range of 1.0 to 10.0. For example, the mono-denier of filaments constituting the cellulous acetate tow may be within a range of 4.0 to 6.0. For example, the mono-denier of the filaments of the front-end plug 33 may be 5.0. Also, a cross-section of the filaments constituting the front-end plug 33 may be a [symbol] shape. Total denier of the front-end plug 33 may be in a range of 20000 to 30000. For example, the total denier of the front-end plug 33 may be within a range of 25000 to 30000. For example, the total denier of the front-end plug 33 may be 28000.

Also, as needed, the front-end plug 33 may include at least one channel. A cross-sectional shape of the channel may be manufactured in various shapes.

The tobacco rod 31 may correspond to the tobacco rod 21 described above with reference to FIG. 4. Therefore, hereinafter, the detailed description of the tobacco rod 31 will be omitted.

The first segment 321 may be formed of cellulous acetate. For example, the first segment 321 may be a tube-type structure having a hollow inside. The first segment 321 may be manufactured by adding a plasticizer (e.g., triacetin) to cellulous acetate tow. For example, mono-denier and total denier of the first segment 321 may be the same as the mono-denier and total denier of the front-end plug 33.

The second segment 322 may be formed of cellulous acetate. Mono denier of filaments constituting the second segment 322 may be in a range of 1.0 to 10.0. For example, the mono denier of the filaments of the second segment 322 may be within a range of about 8.0 to about 10.0. For example, the mono denier of the filaments of the second segment 322 may be 9.0. Also, a cross-section of the filaments of the second segment 322 may be a [symbol] shape. Total denier of the second segment 322 may be in a range of 20000 to 30000. For example, the total denier of the second segment 322 may be 25000.

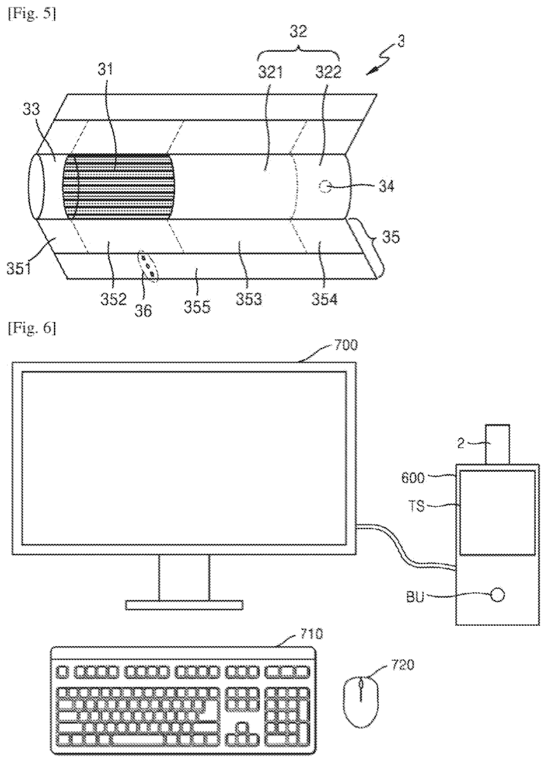

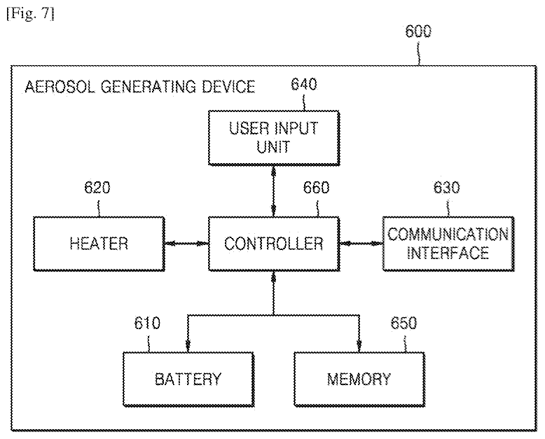

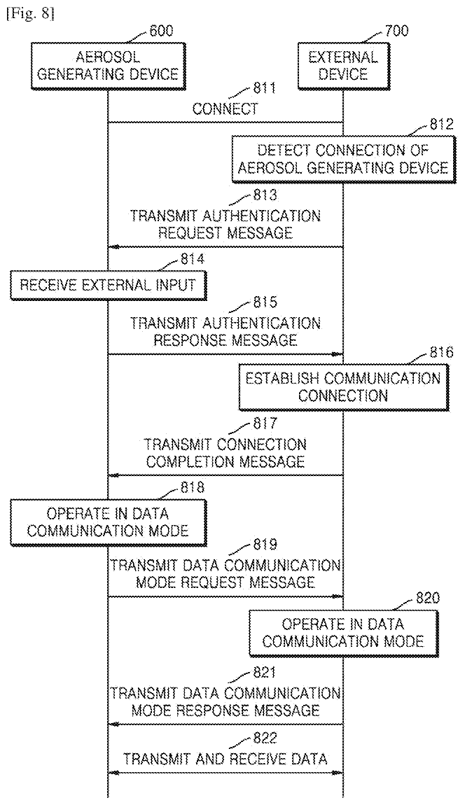

FIG. 6 is a block diagram illustrating an example in which an aerosol generating device is communicatively connected to an external device, according to an embodiment.

An aerosol generating device 600 may refer generically to a smoking system. In one embodiment, the aerosol generating device 600 may be an electrical heating type smoking system that heats a cigarette 2 to generate an aerosol.

The aerosol generating device 600 may include a battery, a heater, a memory, a communication interface, and a user input unit, and so on, but those skilled in the art related to the present embodiment can understand that some of the listed components may be omitted or new components may be added thereto. In this case, the user input unit may include an operation button BU and a touch screen TS.

In one embodiment, the aerosol generating device 600 may include product-related data. For example, the product-related data may include product names, product ingredients, a heating profile for each product, and so on. The aerosol generating device 600 may control a heater based on the beating profile for each product.

In addition, the aerosol generating device 600 may include data acquired from a user and data acquired while using the aerosol generating device 600. The data acquired from the user may include personal information and preference information of the user. For example, the personal information may include age, gender, address, occupation, identification information, and so on. Data acquired during a use process may include an average puff strength, an average number of puffs per puff series, the number of smoking per day, smoking time per day, a smoking area, the frequency of use for each product, and so on.

An external device 700 may be a tablet personal computer (PC), a PC, a personal digital assistant (PDA), a laptop computer, a micro server, or a non-mobile computing device, but is not limited thereto. The aerosol generating device 600 may be communicatively connected to the external device 700.

In one embodiment, the aerosol generating device 600 may be communicatively connected to the external device 700 by wire or wirelessly. The aerosol generating device 600 may communicatively connected to the external device 700 to transmit and receive various data. For example, the aerosol generating device 600 may transmit product-related data (for example, a heating profile for each product) to the external device 700.

The external device 700 may be connected to various input devices, such as a keyboard 710 and/or a mouse 720.

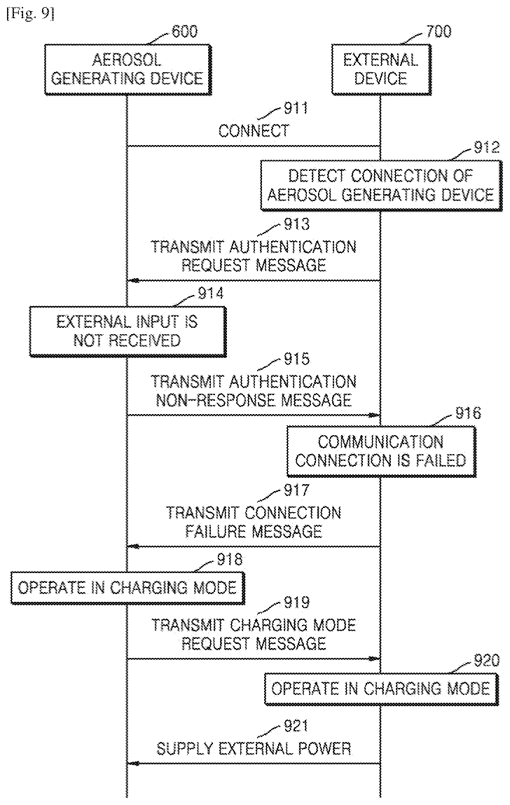

FIG. 7 is a block diagram illustrating a hardware configuration of the aerosol generating device according to the embodiment.

Referring to FIG. 7, the aerosol generating device 600 may include a battery 610, a heater 620, a communication interface 630, a user input unit 640, a memory 650, and a controller 660. However, an internal structure of the aerosol generating device 600 is not limited to the structure illustrated in FIG. 7. Those skilled in the art related to the present embodiments can understand that some of the hardware components illustrated in FIG. 7 may be omitted or new components may be further added thereto, depending on designs of the aerosol generating device 600.

In one embodiment, the aerosol generating device 600 may be composed of only a main body, and in this case, the hardware components included in the aerosol generating device 600 are included in the main body. In another embodiment, the aerosol generating device 600 may be composed of a main body and a cartridge, and hardware components included in the aerosol generating device 600 may be separately located in the main body and the cartridge. Alternatively, at least some of the hardware components included in the aerosol generating device 600 may be included in the main body and the cartridge.

Hereinafter, operations of the respective components are described without limiting spaces where the respective components included in the aerosol generating device 600 are provided.

The battery 610 supplies power for operating the aerosol generating device 600. That is, the battery 610 may supply power such that the heater 620 can be heated. In addition, the battery 610 may supply power required for operations of other hardware components included in the aerosol generating device 600, that is, the communication interface 630, the user input unit 640, the memory 650, and the controller 660. The battery 610 may be a rechargeable battery or a disposable battery. For example, the battery 610 may be a lithium polymer (LiPoly) battery, but is not limited thereto.

The heater 620 receives power from the battery 610 under control by the controller 660. The heater 620 may receive power from the battery 610 to heat the cigarette 2 (in FIG. 6) inserted into the aerosol generating device 600 or heat a cartridge mounted in the aerosol generating device 600.

The heater 620 may be in a main body of the aerosol generating device 600. Alternatively, when the aerosol generating device 600 is composed of a main body and a cartridge, the heater 620 may be in the cartridge. When the heater 620 is in the cartridge, the heater 620 may receive power from the battery 610 in at least one of the main body and the cartridge.

The heater 620 may be formed of any suitable electrically resistive material. For example, the suitable electrically resistive material may be titanium, zirconium, tantalum, platinum, nickel, cobalt, chromium, hafnium, niobium, molybdenum, tungsten, tin, gallium, manganese, iron, copper, stainless steel, nichrome, or an alloy thereof, but is not limited thereto. In addition, the heater 620 may be composed of a metal heating wire, a metal hot plate on which an electrically conductive track is arranged, a ceramic heating element, and so on, but is not limited thereto.

In one embodiment, the heater 620 may be included in a cartridge. The cartridge may include the heater 620, a liquid delivery unit, and a liquid storage. An aerosol generating material accommodated in the liquid storage moves to the liquid delivery unit, and the heater 620 heats the aerosol generating material absorbed in the liquid delivery unit to generate an aerosol. For example, the heater 620 may include a material, such as nickel chrome, and may be wound around or arranged adjacent to the liquid delivery unit.

In another embodiment, the heater 620 may heat a cigarette inserted into an accommodation space of the aerosol generating device 600. As a cigarette is accommodated in the accommodation space of the aerosol generating device 600, the heater 620 may be inside and/or outside the cigarette. Thus, the heater 620 may heat the aerosol generating material of the cigarette to generate an aerosol.

In addition, the heater 620 may be an induction heating type heater. The heater 620 may include a conductive coil for heating a cigarette or a cartridge by using an induction heating method, and the cigarette or cartridge may include a susceptor that may be heated by an induction heating type heater.

The communication interface 630 may be communicatively connected to the external device 700 (in FIG. 6), an external server, and so on by wire or wirelessly. In one embodiment, the aerosol generating device 600 may be communicatively connected to the external device 700 by wire. Wire communication may include, for example, universal serial bus (USB), high definition multimedia interface (HDMI), recommended standard 232 (RS-232), plain old telephone service (POTS), and so on.

In another embodiment, the aerosol generating device 600 may be communicatively connected to the external device 700 through wireless communication without physical input/output terminals. For example, the aerosol generating device 600 may be connected to the external device 700 through various communication methods, such as Bluetooth, Bluetooth Low Energy, Wi-Fi, and Zigbee. However, the communication method is not limited thereto and may be implemented by various interfaces depending on implementation examples.

The user input unit 640 may include an input/output (I/O) interfacing unit (for example, buttons or a touch screen) that receives information input from a user or outputs information to the user.

However, the aerosol generating device 600 may also be implemented by selecting only some of the various examples of the user input unit 640 described above.

The memory 650 is hardware that stores various data processed by the aerosol generating device 600, and the memory 650 may store data processed by the controller 660 and data to be processed. The memory 650 may be implemented in various types, for example, a random access memory (RAM), such as dynamic random access memory (DRAM) or static random access memory (SRAM), a read-only memory (ROM), and an electrically erasable programmable read-only memory (EEPROM).

The memory 650 may store an operation time of the aerosol generating device 600, the greatest number of puffs, a current number of puffs, at least one heating profile, at least one power profile, and data on a smoking pattern of a user.

The controller 660 is hardware that controls all operations of the aerosol generating device 600. The controller 660 includes at least one processor. The processor may be implemented by an array of a plurality of logic gates or may be implemented by a combination of a general-purpose microprocessor and a memory in which programs executable by the microprocessor are stored. Also, those skilled in the art to which the present embodiment belongs can understand that the processor may be implemented by other types of hardware.

FIG. 8 is a flowchart illustrating an operation of an aerosol generating device when an external input is received, according to an embodiment.

Referring to FIGS. 6 to 8, in operation 811, the aerosol generating device 600 may be connected to the external device 700 through the communication interface 630. According to one embodiment, the communication interface 630 may be a wired communication interface. For example, the wired communication interface may be a USB communication interface. According to another embodiment, the communication interface 630 may be a wireless communication interface. For example, the wireless communication interface may be any one of Bluetooth, Bluetooth Low Energy, Wi-Fi, and Zigbee.

In this case, when the aerosol generating device 600 is communicatively connected to the external device 700 by using a wired communication interface, the aerosol generating device 600 may operate in either a data communication mode or a charging mode based on whether a preset external input is entered. In addition, when the aerosol generating device 600 is communicatively connected to the external device 700 by using a wireless communication interface, the aerosol generating device 600 may only operate in a data communication mode when a preset external input is entered. However, the present disclosure is not limited thereto. For example, if the external device 700 includes a separate wireless charging device, even when the aerosol generating device 600 is communicatively connected to the external device 700 through a wireless communication interface, the aerosol generating device 600 may operate in either a data communication mode or a charging mode based on whether a preset external input is entered.

In operation 812, the external device 700 may detect a connection of the aerosol generating device 600.

In operation 813, the external device 700 may transmit an authentication request message to the aerosol generating device 600 when detecting the connection of the aerosol generating device 600.

In operation 814, after receiving the authentication request message from the external device 700, when external input is received from a user within a preset time, the aerosol generating device 600 may determine that the external input is received.

The aerosol generating device 600 may include the operation button BU as the user input unit 640. In an embodiment, the aerosol generating device 600 may perform a preset operation according to the number and/or duration of pressing the operation button BU by a user. For example, preheating of the heater 620 may start when a user presses the operation button BU once for two seconds, or heating and cleaning may be performed when the user quickly presses the operation button BU five times.

According to one embodiment, an external input may indicate that a user presses the operation button BU a preset number of times. In this case, the preset number (for example, three times) may not be described in a product manual of the aerosol generating device 600. As described below, when an external input is received, the aerosol generating device 600 is in a state in which data may be transmitted to and received from the external device 700, and in order to prevent random people from accessing data of the aerosol generating device 600, it is preferable that the preset number defined for an external input is disclosed only to a developer of a product.

In addition, the external input is not limited to pressing of the operation button BU a preset number of times. For example, the external input may be set to be difficult for random people to guess, by combining the number of pressing of the operation button BU and the pressing time thereof.

The aerosol generating device 600 may include the touch screen TS as the user input unit 640. When receiving an authentication request message from the external device 700, the aerosol generating device 600 may display a screen for inputting a password on the touch screen TS. According to one embodiment, the external input may indicate that a user inputs a preset password onto the touch screen TS.

In operation 815, the aerosol generating device 600 may transmit an authentication response message to the external device 700 when it is determined that the external input is received.

In operation 816, when receiving the authentication response message from the aerosol generating device 600, the external device 700 may establish a communication connection with the aerosol generating device 600.

In operation 817, the external device 700 may transmit a communication connection completion message to the aerosol generating device 600 after the communication connection is established.

In operation 818, when receiving the communication connection completion message from the external device 700, the aerosol generating device 600 may operate in a data communication mode.

In operation 819, the aerosol generating device 600 may transmit a data communication mode request message to the external device 700 when operating in the data communication mode.

In operation 820, when receiving the data communication mode request message from the aerosol generating device 600, the external device 700 may operate in the data communication mode.

In operation 821, the external device 700 may transmit a data communication mode response message to the aerosol generating device 600 when operating in the data communication mode.

In operation 822, the aerosol generating device 600 may transmit and receive data to and from the external device 700. In this case, the data communication mode indicates a state in which data may be transmitted and received between the aerosol generating device 600 and the external device 700. That is, a user of the external device 700 has access rights to data (for example, product information) of the aerosol generating device 600. Likewise, the user of the aerosol generating device 600 has access rights to data (for example, update information) of the external device 700.

FIG. 9 is a flowchart illustrating an operation of an aerosol generating device when an external input is not received, according to an embodiment.

Referring to FIGS. 6 to 9, in operation 911, the aerosol generating device 600 may be connected to the external device 700 through the communication interface 630. According to one embodiment, the communication interface 630 may be a wired/wireless communication interface.

In operation 912, the external device 700 may detect a connection of the aerosol generating device 600.

In operation 913, when the external device 700 detects the connection of the aerosol generating device 600, the external device 700 may transmit an authentication request message to the aerosol generating device 600.

In operation 914, after receiving the authentication request message from the external device 700, the aerosol generating device 600 may determine that no external input is received when the external input is not received from a user within a preset time.

The aerosol generating device 600 may include the operation button BU as the user input unit 640. According to one embodiment, the external input may indicate that a user presses the operation button BU a preset number of times. In this case, the preset number (for example, three times) may not be described in a product manual of the aerosol generating device 600. In addition, the external input may be set to be difficult for random people to guess, by combining the number of pressing of the operation button BU and a pressing time thereof.

The aerosol generating device 600 may include the touch screen TS as the user input unit 640. When receiving an authentication request message from the external device 802, the aerosol generating device 600 may display a screen for inputting a password on the touch screen TS. According to one embodiment, the external input may be a user inputting a preset password using the touch screen TS.

In operation 915, when it is determined that no external input is received, the aerosol generating device 600 may transmit an authentication non-response message to the external device 700.

In operation 916, when receiving the authentication non-response message from the aerosol generating device 600, the external device 700 may not establish a communication connection with the aerosol generating device 600 (that is, the communication connection is failed).

In operation 917, when the communication connection is failed, the external device 700 may transmit a communication connection failure message to the aerosol generating device 600.

In operation 918, when receiving the communication connection failure message from the external device 700, the aerosol generating device 600 may operate in a charging mode.

In operation 919, the aerosol generating device 600 may transmit a charging mode request message to the external device 700 when operating in the charging mode.

In operation 920, the external device 700 may operate in the charging mode when receiving the charging mode request message from the aerosol generating device 600. In this case, the charging mode may indicate a state in which power of the aerosol generating device 600 is charged, and data may not be transmitted and received between the aerosol generating device 600 and the external device 700. That is, a user of the external device 700 does not have access rights to data (for example, product information) of the aerosol generating device 600. In addition, the user of the aerosol generating device 600 does not have access rights to data (for example, update information) of the external device 700.

In operation 921, the external device 700 may supply external power to the battery 610 of the aerosol generating device 600 when operating in the charging mode.

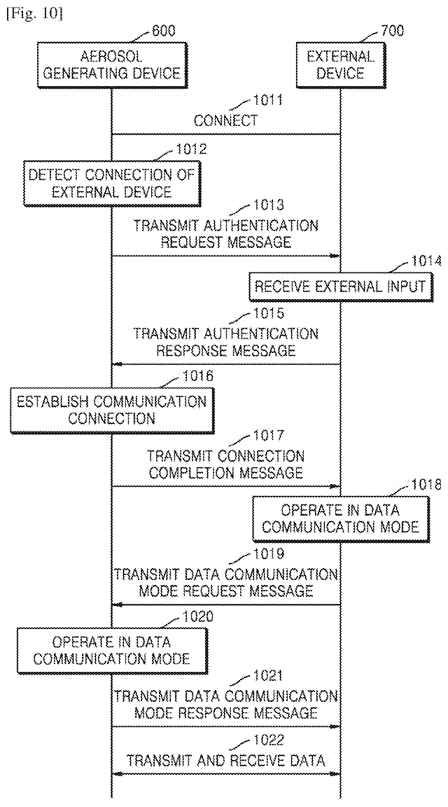

FIG. 10 is a flowchart illustrating an operation of an aerosol generating device when an external input is received, according to another embodiment.

A difference between the embodiment illustrated in FIG. 10 and the embodiment illustrated in FIG. 8 is that an external input is received through the aerosol generating device 600 in the embodiment of FIG. 8 but an external input is received through the external device 700 in the embodiment of FIG. 10. Hereinafter, redundant descriptions are omitted, and differences therebetween are mainly described.

Referring to FIGS. 6 to 10, in operation 1011, the aerosol generating device 600 may be connected to the external device 700 through the communication interface 630. According to one embodiment, the communication interface 630 may be a wired/wireless communication interface.

In operation 1012, the aerosol generating device 600 may detect a connection of the external device 700.

In operation 1013, the aerosol generating device 600 may transmit an authentication request message to the external device 700 when detecting the connection of the external device 700.

In operation 1014, after receiving the authentication request message from the aerosol generating device 600, the external device 700 may determine that an external input is received when the external input is received from a user within a preset time.

The external device 700 may include a display unit that displays an execution screen of a preset syntax analysis program (for example, PC Tool) and the keyboard 710 that receives an external input. According to one embodiment, the external input may be a decryption approval command that is input through the keyboard 710. In this way, the security of the external input is improved, because a preset decryption approval command must be entered through a preset syntax analysis program to enter the external input into the external device 700.

In operation 1015, when it is determined that the external input is received, the external device 700 may transmit an authentication response message to the aerosol generating device 600.

In operation 1016, when receiving the authentication response message from the external device 700, the aerosol generating device 600 may establish a communication connection with the external device 700.

In operation 1017, the aerosol generating device 600 may transmit a communication connection completion message to the external device 700 after establishing the communication connection.

In operation 1018, when receiving the communication connection completion message from the aerosol generating device 600, the external device 700 may operate in a data communication mode.

In operation 1019, the external device 700 may transmit a data communication mode request message to the aerosol generating device 600 when operating in the data communication mode.

In operation 1020, when receiving the data communication mode request message from the external device 700, the aerosol generating device 600 may operate in the data communication mode.

In operation 1021, the aerosol generating device 600 may transmit a data communication mode response message to the external device 700 when operating in the data communication mode.

In operation 1022, the aerosol generating device 600 may transmit and receive data to and from the external device 700. In this case, the data communication mode indicates a state in which data may be transmitted and received between the aerosol generating device 600 and the external device 700. That is, a user of the external device 700 has access rights to data (for example, product information) of the aerosol generating device 600. In addition, the user of the aerosol generating device 600 has access rights to data (for example, update information) of the external device 700.

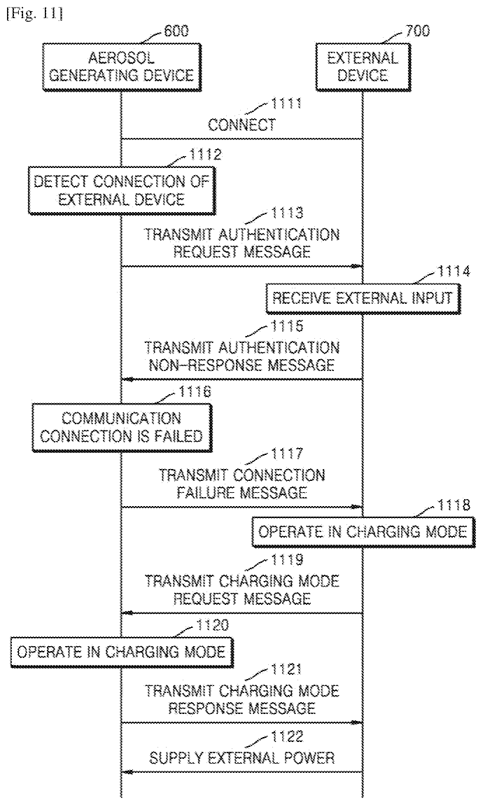

FIG. 11 is a flowchart illustrating an operation of an aerosol generating device when an external input is not received, according to another embodiment.

Referring to FIGS. 6 to 11, in operation 1111, the aerosol generating device 600 may be connected to the external device 700 through the communication interface 630. According to one embodiment, the communication interface 630 may be a wired/wireless communication interface.

In operation 1112, the aerosol generating device 600 may detect a connection of the external device 700.

In operation 1113, when the aerosol generating device 600 detects the connection of the external device 700, the aerosol generating device 600 may transmit an authentication request message to the external device 700.

In operation 1114, after receiving the authentication request message from the aerosol generating device 600, the external device 700 may determine that no external input is received when not receiving the external that is input from a user within a preset time.

The external device 700 may include a display unit that displays an execution screen of a preset syntax analysis program (for example, PC Tool) and the keyboard 710 that receives the external input. According to one embodiment, the external input may be a decryption approval command.

In operation 1115, when it is determined that no external input is received, the external device 700 may transmit an authentication non-response message to the aerosol generating device 600.

In operation 1116, when receiving the authentication non-response message from the external device 700, the aerosol generating device 600 may not establish a communication connection with the external device 700 (that is, the communication connection is failed).

In operation 1117, when the communication connection is failed, the aerosol generating device 600 may transmit a communication connection failure message to the external device 700.

In operation 1118, when receiving the communication connection failure message from the aerosol generating device 600, the external device 700 may operate in a charging mode.

In operation 1119, the external device 700 may transmit a charging mode request message to the aerosol generating device 600 when operating in the charging mode.

In operation 1120, when receiving the charging mode request message from the external device 700, the aerosol generating device 600 may operate in the charging mode. In this case, the charging mode may indicate a state in which power of the aerosol generating device 600 is accumulated, and data may not be transmitted and received between the aerosol generating device 600 and the external device 700.

In operation 1121, the aerosol generating device 600 may transmit a charging mode response message to the external device 700 when operating in the charging mode.

In operation 1122, when receiving the charging mode response message from the aerosol generating device 600, the external device 700 may supply external power to the battery 610 of the aerosol generating device 600.

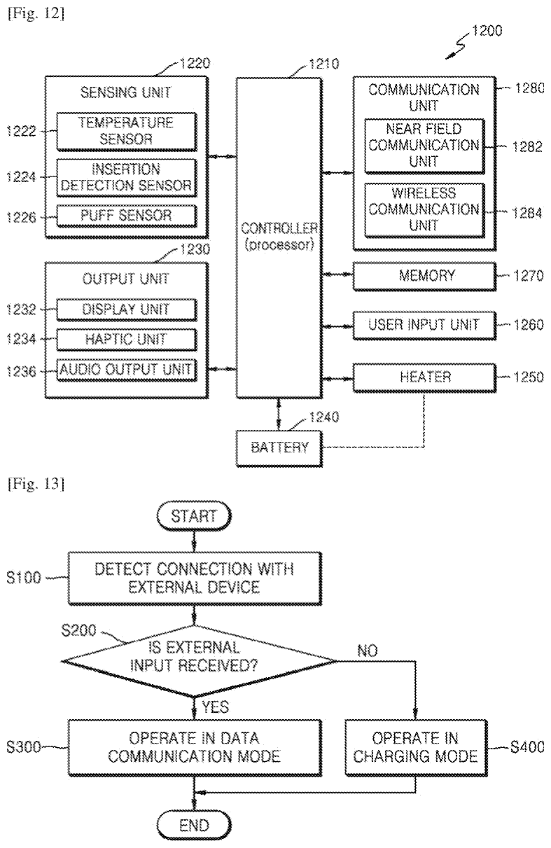

FIG. 12 is a block diagram of an aerosol generating device 1200 according to another embodiment.

The aerosol generating device 1200 may include a controller 1210, a sensing unit 1220, an output unit 1230, a battery 1240, a heater 1250, a user input unit 1260, a memory 1270, and a communication unit 1280. However, the internal structure of the aerosol generating device 1200 is not limited to those illustrated in FIG. 12. That is, according to the design of the aerosol generating device 1200, it will be understood by one of ordinary skill in the art that some of the components shown in FIG. 12 may be omitted or new components may be added.

The sensing unit 1220 may sense a state of the aerosol generating device 1200 and a state around the aerosol generating device 1200, and transmit sensed information to the controller 1210. Based on the sensed information, the controller 1210 may control the aerosol generating device 1200 to perform various functions, such as controlling an operation of the heater 1250, limiting smoking, determining whether an aerosol generating article (e.g., a cigarette, a cartridge, or the like) is inserted, displaying a notification, or the like.

The sensing unit 1220 may include at least one of a temperature sensor 1222, an insertion detection sensor, and a puff sensor 1226, but is not limited thereto.

The temperature sensor 1222 may sense a temperature at which the heater 1250 (or an aerosol generating material) is heated. The aerosol generating device 1200 may include a separate temperature sensor for sensing the temperature of the heater 1250, or the heater 1250 may serve as a temperature sensor. Alternatively, the temperature sensor 1222 may also be arranged around the battery 1240 to monitor the temperature of the battery 1240. In an embodiment, the temperature sensor 1222 may measure the temperature of the heater 1250 before being heated.

The insertion detection sensor 1224 may sense insertion and/or removal of an aerosol generating article. For example, the insertion detection sensor 1224 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article. In an embodiment, the insertion detection sensor 1224 may determine continuous use when, after detecting insertion of an aerosol-generating article, it detects insertion of an aerosol-generating article again within a predetermined period of time after the one-smoke series ends.

The puff sensor 1226 may sense a user's puff on the basis of various physical changes in an airflow passage or an airflow channel. For example, the puff sensor 1226 may sense a user's puff on the basis of any one of a temperature change, a flow change, a voltage change, and a pressure change.

The sensing unit 1220 may include, in addition to the temperature sensor 1222, the insertion detection sensor 1224, and the puff sensor 1226 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1230 may output information on a state of the aerosol generating device 1200 and provide the information to a user. The output unit 1230 may include at least one of a display unit 1232, a haptic unit 1234, and a sound output unit 1236, but is not limited thereto. When the display unit 1232 and a touch pad form a layered structure to form a touch screen, the display unit 1232 may also be used as an input device in addition to an output device.

The display unit 1232 may visually provide information about the aerosol generating device 1200 to the user. For example, information about the aerosol generating device 1200 may mean various pieces of information, such as a charging/discharging state of the battery 1240 of the aerosol generating device 1200, a preheating state of the heater 1250, an insertion/removal state of an aerosol generating article, or a state in which the use of the aerosol generating device 1200 is restricted (e.g., sensing of an abnormal object), or the like, and the display unit 1232 may output the information to the outside. The display unit 1232 may be, for example, a liquid crystal display panel (LCD), an organic light-emitting diode (OLED) display panel, or the like. In addition, the display unit 1232 may be in the form of a light-emitting diode (LED) light-emitting device.

The haptic unit 1234 may tactilely provide information about the aerosol generating device 1200 to the user by converting an electrical signal into a mechanical stimulus or an electrical stimulus. For example, the haptic unit 1234 may include a motor, a piezo-electric element, or an electrical stimulation device.

The sound output unit 1236 may audibly provide information about the aerosol generating device 1200 to the user. For example, the sound output unit 1236 may convert an electrical signal into a sound signal and output the same to the outside.

The battery 1240 may supply power used to operate the aerosol generating device 1200. The battery 1240 may supply power such that the heater 1250 may be heated. In addition, the battery 1240 may supply power required for operations of other components (e.g., the sensing unit 1220, the output unit 1230, the user input unit 1260, the memory 1270, and the communication unit 1280) in the aerosol generating device 1200. The battery 1240 may be a rechargeable battery or a disposable battery. For example, the battery 1240 may be a lithium polymer (LiPoly) battery, but is not limited thereto.

The heater 1250 may receive power from the battery 1240 to heat an aerosol generating material. Although not illustrated in FIG. 12, the aerosol generating device 1200 may further include a power conversion circuit (e.g., a direct current (DC)/DC converter) that converts power of the battery 1240 and supplies the same to the heater 1250. In addition, when the aerosol generating device 1200 generates aerosols in an induction heating method, the aerosol generating device 1200 may further include a DC/alternating current (AC) that converts DC power of the battery 1240 into AC power.

The controller 1210, the sensing unit 1220, the output unit 1230, the user input unit 1260, the memory 1270, and the communication unit 1280 may each receive power from the battery 1240 to perform a function. Although not illustrated in FIG. 12, the aerosol generating device 1200 may further include a power conversion circuit that converts power of the battery 1240 to supply the power to respective components, for example, a low dropout (LDO) circuit, or a voltage regulator circuit.

In an embodiment, the heater 1250 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1250 may be implemented by a metal wire, a metal plate on which an electrically conductive track is arranged, a ceramic heating element, or the like, but is not limited thereto.

In another embodiment, the heater 1250 may be a heater of an induction heating type. For example, the heater 1250 may include a suspector that heats an aerosol generating material by generating heat through a magnetic field applied by a coil.

In one embodiment, the heater 1250 may include a plurality of heaters. For example, the beater 1250 may include a first heater for heating the cigarette and a second heater for heating the liquid.

The user input unit 1260 may receive information input from the user or may output information to the user. For example, the user input unit 1260 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 12, the aerosol generating device 1200 may further include a connection interface, such as a universal serial bus (USB) interface, and may connect to other external devices through the connection interface, such as the USB interface, to transmit and receive information, or to charge the battery 1240.

The memory 1270 is a hardware component that stores various types of data processed in the aerosol generating device 1200, and may store data processed and data to be processed by the controller 1210. The memory 1270 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1270 may store an operation time of the aerosol generating device 1200, the maximum number of puffs, the current number of puffs, at least one temperature profile, data on a user's smoking pattern, etc. In an embodiment, memory 1270 may store a plurality of heating profiles. Also, the memory 1270 may store a plurality of preheating profiles defining preheating sections among heating profiles. The memory 1270 may store a plurality of preheating profiles described with reference to FIGS. 8 and 9.

The communication unit 1280 may include at least one component for communication with another electronic device. For example, the communication unit 1280 may include a short-range wireless communication unit 1282 and a wireless communication unit 1284.

The short-range wireless communication unit 1282 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1284 may include a cellular network communication unit, an Internet communication unit, a computer network (e.g., local area network (LAN) or wide area network (WAN)) communication unit, or the like, but is not limited thereto. The wireless communication unit 1284 may also identify and authenticate the aerosol generating device 1200 within a communication network by using subscriber information (e.g., International Mobile Subscriber Identifier (IMSI)).

The controller 1210 may control general operations of the aerosol generating device 1200. In an embodiment, the controller 1210 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

FIG. 13 is a flowchart illustrating an operating method of an aerosol generating device, according to an embodiment. In this case, of course, the embodiments described above with reference to FIG. 13 and the embodiment described with reference to FIG. 13 may be applied to the operating method of the aerosol generating device.

Referring to FIGS. 1 to 11 and FIG. 13, an operating method of an aerosol generating device may include operation S100 of detecting connection with the external device 700 through the communication interface 630, operation S200 of determining whether an external input is received through the user input unit 640 within a preset time after detecting the connection between the communication interface 630 of the aerosol generating device 600 and the external device 700, operation S300 of communicating with the external device 700 when an external input is received through the user input unit 640 within the preset time, and operation S400 of receiving external power through the communication interface 630 and performing a charging operation for the battery 610 with the received external power if the external input is not received through the user input unit 640 within the preset time.

Specifically, in operation S100, the communication interface 630 may be a wired communication interface according to one embodiment. For example, the wired communication interface may be a USB communication interface. According to another embodiment, the communication interface 630 may be a wireless communication interface. For example, the wireless communication interface may be any one of Bluetooth, Bluetooth Low Energy, Wi-Fi, and Zigbee.

Thereafter, in operation S200, according to one embodiment, the external input may indicate that a user presses the operation button BU a preset number of times. In this case, the preset number (for example, three times) may not be disclosed in a product manual of the aerosol generating device 600. When an external input is received, the aerosol generating device 600 is in a state in which data may be transmitted to and received from the external device 700. In this regard, in order to prevent random people from accessing product information of the aerosol generating device 600, it is preferable that the preset number for an external input is disclosed only to a developer of a product.

In addition, the external input is not limited to pressing of the operation button BU a preset number of times. For example, the external input may be set to be difficult for random people to guess, by combining the number of pressing of the operation button BU and the pressing time thereof.

The aerosol generating device 600 may include the touch screen TS as the user input unit 640. When receiving an authentication request message from the external device 700, the aerosol generating device 600 may display a screen for inputting a password on the touch screen TS. According to one embodiment, the external input may indicate that a user inputs a preset password onto the touch screen TS.

The external device 700 may include a display unit that displays an execution screen of a preset syntax analysis program (for example, PC Tool) and the keyboard 710 that receives an external input. According to one embodiment, the external input may be a decryption approval command that is input through the keyboard 710. In this way, the security of the external input is improved, because a preset decryption approval command must be entered through a preset syntax analysis program to enter the external input into the external device 700.

In operation S300, the aerosol generating device 600 and the external device 700 may operate in a data communication mode. In this case, the data communication mode indicates a state in which data may be transmitted and received between the aerosol generating device 600 and the external device 700. That is, a user of the external device 700 has access rights to data (for example, product information) of the aerosol generating device 600. In addition, the user of the aerosol generating device 600 has access rights to data (for example, update information) of the external device 700.

In operation S400, the aerosol generating device 600 and the external device 700 may operate in a charging mode. In this case, the charging mode may indicate a state in which power of the aerosol generating device 600 is charged, and data may not be transmitted and received between the aerosol generating device 600 and the external device 700. That is, a user of the external device 700 does not have access rights to data (for example, product information) of the aerosol generating device 600. In addition, the user of the aerosol generating device 600 does not have access rights to data (for example, update information) of the external device 700.

Those of ordinary skill in the art related to the present embodiments may understand that various changes in form and details can be made therein without departing from the scope of the characteristics described above. Therefore, the disclosed methods should be considered in a descriptive point of view, not a restrictive point of view. The scope of the present disclosure is defined by the appended claims rather than by the foregoing description, and all differences within the scope of equivalents thereof should be construed as being included in the present disclosure.

1. An aerosol generating device comprising:
a heater;
a battery configured to supply power to the heater;
a communication interface connectable to an external device; and
a controller configured to communicate with the external device only after a preset external input is received while the communication interface is connected to the external device.

2. The aerosol generating device of claim 1, further comprising a user input unit configured to receive the external input.

3. The aerosol generating device of claim 2, wherein the user input unit comprises an operation button, and the external input is pressing the operation button a predetermined number of times.

4. The aerosol generating device of claim 2, wherein the user input unit comprises a touch screen for displaying a virtual keyboard, and the external input is a preset password.

5. The aerosol generating device of claim 1, wherein the external device includes a display unit for displaying an execution screen of a syntax analysis program and a keyboard for receiving the external input, and
the external input is a decryption approval command.

6. The aerosol generating device of claim 1, wherein the communication interface is a universal serial bus (USB) communication interface.

7. The aerosol generating device of claim 2, wherein the controller is further configured to, if the external input is not received through the user input unit within a preset time after a connection between the communication interface and the external device is detected, receive external power through the communication interface and perform a charging operation for the battery with the received external power.

8. The aerosol generating device of claim 1, wherein the communication interface is a wireless communication interface for wirelessly connecting with the external device.

9. The aerosol generating device of claim 8, wherein the wireless communication interface comprises any one of Bluetooth, Bluetooth Low Energy, Wi-Fi, and Zigbee.

10. The aerosol generating device of claim 1, further comprising a memory configured to store a plurality of heating profiles of the heater.

11. An operating method of an aerosol generating device including a heater and a battery supplying power to the heater, the operating method comprising:
detecting a connection with an external device through a communication interface;
determining whether a preset external input is received through a user input unit while the detected connection is maintained; and
communicating with the external device when the external input is received through the user input unit.

12. The operating method of claim 11, wherein the user input unit comprises an operation button, and the external input is pressing the operation button a predetermined number of times.

13. The operating method of claim 11, wherein
the user input unit comprises a touch screen that displays a virtual keyboard, and
the external input is a preset password.

14. The operating method of claim 11, wherein
the external device includes a display unit for displaying an execution screen of a syntax analysis program and a keyboard for receiving the external input, and
the external input is a decryption approval command.

15. The operating method of claim 11, further comprising, when the external input is not received through the user input unit within the preset time, receiving external power through the communication interface, and charging the battery with the received external power.
